(19) United States
(12) Patent Application Publication
(10) Pub. No.: US 2013/0310553 A1
(43) Pub. Date: Nov. 21, 2013

(54) METHOD FOR PRECIPITATING AND RE-DISSOLVING BETA-GLUCAN

(71) Applicant: Wintershall Holding GmbH, Kassel (DE)

(72) Inventors: Tobias Käppler, Maxdorf (DE); Thorsten Haas, Stuttgart (DE); Julia Kristiane Schmidt, Heidelberg (DE); Christian Fleck, Leimen (DE); Stephan Freyer, Neustadt (DE); Robert Bayer, Sinsheim (DE)

(73) Assignee: Wintershall Holding GmbH, Kassel (DE)

(21) Appl. No.: 13/893,532

(22) Filed: May 14, 2013

Related U.S. Application Data
(60) Provisional application No. 61/647,550, filed on May 16, 2012.

(51) Int. Cl. C08B 37/00

(52) U.S. Cl. CPC C08B 37/0024
USPC 536/123.12

(57) ABSTRACT

The present invention relates to novel methods for precipitating beta-glucan (β-glucan) by using high-molecular polyethylene glycol (PEG) and re-dissolving the precipitated β-glucan in a suitable medium. The novel method of the present invention may also include drying the precipitated β-glucan and/or swelling the precipitated b-glucan in a suitable solution before re-dissolving the β-glucan.

The present invention relates to novel methods for precipitating beta-glucan (β-glucan) by using high-molecular polyethylene glycol (PEG) and re-dissolving the precipitated β-glucan in a suitable medium. The novel method of the present invention may also include drying the precipitated β-glucan and/or swelling the precipitated b-glucan in a suitable solution before re-dissolving the β-glucan.

β-glucans are known well-conserved components of cell walls in several microorganisms, particularly in fungi and yeast (Novak, Endocrine, Metabol & Immune Disorders—Drug Targets (2009), 9: 67-75). Biochemically, β-glucans are non-cellulosic polymers of β-glucose linked via glycosidic β(1-3) bonds exhibiting a certain branching pattern with β(1-6) bound glucose molecules (Novak, loc cit). A large number of closely related β-glucans exhibit a similar branching pattern such as schizophyllan, scleroglucan, pendulan, cinerian, laminarin, lentinan and pleuran, all of which exhibit a linear main chain of β-D-(1-3)-glucopyranosyl units with a single β-D-glucopyranosyl unit (1-6) linked to a β-D-glucopyranosyl unit of the linear main chain with an average branching degree of about 0,3 (Novak, loc cit; EP-B1 463540; Stahmann, Appl Environ Microbiol (1992), 58: 3347-3354; Kim, Biotechnol Letters (2006), 28: 439-446; Nikitina, Food Technol Biotechnol (2007), 45: 230-237). At least two of said β-glucans—schizophyllan and scleroglucan—even share an identical structure and differ only slightly in their molecular mass, i.e. in their chain length (Survase, Food Technol Biotechnol (2007), 107-118).

Such β-glucans are widely used as thickeners in the field of enhanced oil recovery (EOR; also referred to as tertiary oil recovery, TOR or as improved oil recovery, IOR) (Survase, loc cit).

In mineral oil production, a distinction is made between primary, secondary and tertiary production.

In primary production, after sinking of the well into the deposit, the mineral oil flows by itself through the well to the surface owing to the autogenous pressure of the deposit. However, in general only from about 5 to 10% of the amount of mineral oil present in the deposit, depending on the type of deposit, can be extracted by means of primary production, after which the autogenous pressure is no longer sufficient for extraction.

Secondary production is therefore used after the primary production. In secondary production, further wells are drilled into the mineral oil-carrying formation, in addition to the wells which serve for production of the mineral oil, the so-called production wells. Water and/or steam is forced into the deposit through these so-called injection wells in order to maintain or to further increase the pressure. By forcing in the water, the mineral oil is forced slowly through the cavities in the formation, starting from the injection well, in the direction of the production well. However, this functions only as long as the cavities are completely filled with oil and the water pushes the more viscous oil in front of it. As soon as the low-viscosity water penetrates through cavities, it flows from this time on along the path of least resistance, i.e. through the resulting channel between the injection wells and the production wells, and no longer pushes the oil in front of it. As a general rule, only from about 30 to 35% of the amount of mineral oil present in the deposit can be extracted by means of primary and secondary production.

It is known that the mineral oil yield can be further increased by tertiary oil production measures. Tertiary mineral oil production includes processes in which suitable chemicals are used as assistants for oil production. These include the so-called “polymer flooding”. In polymer flooding, an aqueous solution of a polymer having a thickening effect is forced instead of water through the injection wells into the mineral oil deposit. By forcing in the polymer solution, the mineral oil is forced through said cavities in the formation, starting from the injection well, in the direction of the production well, and the mineral oil is finally extracted via the production well. Owing to the high viscosity of the polymer solution, which is adapted to the viscosity of the mineral oil, the polymer solution can no longer, or at least not so easily, break through cavities as is the case with pure water.

A multiplicity of different water-soluble polymers have been proposed for polymer flooding, i.e. both synthetic polymers, such as, for example, polyacrylamides or copolymers comprising acrylamide and other monomers and also water-soluble polymers of natural origin.

Suitable thickening polymers for tertiary mineral oil production must meet a number of specific requirements. In addition to sufficient viscosity, the polymers must also be thermally very stable and retain their thickening effect even at high salt concentrations.

An important class of polymers of natural origin for polymer flooding comprises branched homopolysaccharides obtained from glucose, e.g., β-glucans as described above. Aqueous solutions of such β-glucans have advantageous physicochemical properties, so that they are particularly suitable for polymer flooding.

It is important for polymer flooding that the aqueous polymer solution used for this purpose comprises no gel particles or other small particles at all. Even a small number of particles having dimensions in the micron range may block the fine pores in the mineral oil formation and may thus at least complicate or even stop the mineral oil production. Polymers for tertiary mineral oil production should therefore have as small proportions as possible of gel particles or other small particles. Suitable methods for filtering such aqueous polymer solutions are described in, e.g., WO 2011/082973.

Many processes for the preparation of β-glucans comprise the cultivation and fermentation of microorganisms capable of synthesizing such biopolymers. For example, EP 271 907 A2, EP 504 673 A1 and DE 40 12 238 A1 disclose processes for the preparation, i.e. the preparation is effected by batchwise fermentation of the fungus Schizophyllum commune with stirring and aeration. The culture medium substantially comprises glucose, yeast extract, potassium dihydrogen phosphate, magnesium sulfate and water. EP 271 907 A2 describes a method for isolating the polysaccharide, in which the culture suspension is first centrifuged and the polysaccharide is precipitated from the supernatant with isopropanol. A second method comprises a pressure filtration followed by an ultrafiltration of the solution obtained, without details of the method having been disclosed. “Udo Rau, “Biosynthese, Produktion and Eigenschaften von extrazellulären Pilz-Glucanen”, Habilitationsschrift, Technical University of Brunswick, 1997, pages 70 to 95” and “Udo Rau, Biopolymers, Editor A. Steinbüchel, Volume 6, pages 63 to 79, WILEY-VCH Publishers, New York, 2002” describe the preparation of schizophyllan by continuous or batchwise fermentation. “GIT Fachzeitung Labor 12/92, pages 1233-1238” describes a continuous preparation of branched β-1,3-glucans with cell recycling. WO 03/016545 A2 discloses a continuous process for the preparation of scleroglucans using Sclerotium rolfsii.

Furthermore, for economic reasons, the concentration of aqueous β-glucan solutions should be as high as possible in order to ensure as little transport effort as possible for transporting the aqueous glucan solutions from the production site to the place of use. For this purpose, β-glucan solutions are usually concentrated by drying, lyophilization and/or precipitation before being transported in order to reduce their weight.

However, concentrated β-glucan solutions having low residual moisture can hardly be re-dissolved in water and viscosity—which is important for the usage of the solution in EOR—is drastically reduced (Rau, Methods in Biotechnology (1999), 10: 43-55, DOI: 10.1007/978-1-59259-261-6_{—}4; Kumar, Am J Food Technol (2011), 6: 781-789).

This technical problem has been solved by the means and methods described herein and as defined in the claims.

Although it was known that precipitation of β-glucans by using polyethylene glycol (PEG; also known as macrogol, Carbowax™, polyethylene oxide (PEO), or polyoxyethylene (POE)) is possible (EP 266 163 A2; Sakurai, Carbohydrate Res (2000), 324: 136-140), the context of PEG-mediated precipitated β-glucan and recovery of viscosity has not been described and methods for recovering viscosity were missing. As has been surprisingly found in context with the present invention, precipitating β-glucan by using high-molecular PEG allows re-dissolving the β-glucan in water and, moreover, thereby allows recovering almost the same viscosity compared to the viscosity of the β-glucan solution before precipitation (in about the same volume as before). As has been found in context with the present invention, the molecular weight of the PEG has a great impact on the precipitation of the β-glucan, whereas the necessary amount of PEG is independent of the β-glucan concentration. The minimal molecular weight of PEG which was found effective in context with the present invention was 1.5 kDa, while molecular weights of at least 8.0 kDa or even 20.0 kDa were found to be most effective. Without being bound by theory, it is believed that high-molecular PEGs may purify the β-glucan, thus allowing easy and efficient re-dissolving and recovery of viscosity. Also, it has been found that an extensive drying of the precipitated, thereby falling below a certain threshold of a minimum residual moisture, appears to be disadvantageous for subsequent re-dissolving of the β-glucan in water. Furthermore, it has been found in context with the present invention that a step of swelling or steeping (generally, the terms “swelling” and “steeping” will be used interchangeably herein) of the precipitated β-glucan before re-dissolving may improve efficacy of the re-dissolving and, moreover, increases the resulting viscosity.

Accordingly, the present invention relates to a method for precipitating and re-dissolving β-glucan comprising the following steps:
(a) contacting an aqueous β-glucan solution with a polyethylene glycol (PEG) having a molecular weight of at least about 1,500 Da, thereby precipitating the β-glucan;
(b) isolating the precipitated β-glucan from the aqueous solution;
(c) optionally drying the precipitated β-glucan of (b);
(d) optionally swelling or steeping the precipitated β-glucan of (b) or (c) in an aqueous solution; and
(e) re-dissolving the precipitated β-glucan of (b), (c) or (d) in water.

The aqueous β-glucan solution may be filtrated, centrifuged or otherwise be treated before being contacted with PEG in order to reduce or fully remove any cells, cell debris and/or other cellular components which accumulated during fermentation of microorganisms producing the β-glucan. Furthermore, for economic reasons, it may be sensible to concentrate the β-glucan solution to be precipitated before contacting it with PEG. This can be performed by several methods known in the art such as, e.g., evaporation, ultracentrifugation, ultrafiltration, nanofiltration, reverse osmosis, precipitation, extraction, adsorption or freezing out. In context with the present invention, the aqueous solution which is contacted with PEG for precipitation has a concentration of at least 2.5 g β-glucan per liter solution. Preferably, the concentration of the aqueous solution has a concentration of 2.5 g to 100 g per liter, more preferably 5 g to 15 g per liter, and most preferably 20 to 50 g per liter.

In context with the method of the present invention, isolation of the precipitated β-glucan may be performed by any suitable methods known in the art and described herein. Such methods comprise, inter alia, centrifugation, sedimentation and filtration.

In context with the present invention, in case a drying step is applied after precipitation of β-glucan with PEG, the residual moisture after drying of the precipitated β-glucan is at least 5% w/w (by weight; g liquid/β-glucan), preferably at least 10% w/w, more preferably at least 15% w/w, more preferably at least 20% w/w, more preferably at least 25% w/w, and most preferably at least 30% w/w. By keeping a residual moisture at or above said minimum values, subsequent re-dissolving of the b-glucan in water is easier and more efficient. Methods suitable for drying β-glucan are generally known in the art and also described and exemplified herein. Such methods comprise, e.g., contact drying, convection drying, or radiation drying. The drying conditions (e.g., duration of drying, temperature, pressure, etc.) may be set in a manner in order to ensure that the residual moisture does not fall below said minimum residual moisture values. The residual moisture of precipitated β-glucan can be determined by methods known in the art and as described herein. Suitable methods comprise, inter alia, mass balance or Karl-Fischer-titration (Fischer, Angew Chem (1935), 48: 394-396).

As mentioned above, a step of swelling or steeping of the precipitated (and dried, if applicable) β-glucan before re-dissolving may improve efficacy of re-dissolving and, more importantly, increases the resulting viscosity. Accordingly, in one embodiment of the method of the present invention, the β-glucan is swelled or steeped in an aqueous solution before re-dissolving in water. The liquid used for swelling or steeping may generally be any liquid in which β-glucan is soluble. Preferably, the liquid is water, more preferably high-purity or, as used interchangeably herein, ultrapure water (also referred to as “aqua purificata” or “aqua purified” according to European Pharmacopoeia (PhEur) or US Pharmacopeia (USP)). However, if deemed appropriate due to easier availability, also non-ultrapure water containing significant amounts of salts is suitable for this purpose. The amount of liquid used for swelling or steeping depends on the concentration of β-glucan. For example, 10 g to 2,000 g, preferably 100 g to 2,000, more preferably 1,000 g to 2000 g liquid (e.g., water) is used for 1 g β-glucan. The swelling or steeping may preferably be performed at temperatures between 10° C. and 60° C., e.g., at about 20° C., 30° C., 40° C. or 50° C. There is no ultimate maximum for a time period of swelling or steeping, however, a maximum of 3 h is preferred. More preferably, the swelling or steeping time period does not exceed 1 h, more preferably 30 min, more preferably 15 min, more preferably 10 min, more preferably 5 min, and most preferably 1 min. Preferably, the swelling or steeping may be performed at an ambient pressure of below 2 bar.

In accordance with the method described and provided herein, after precipitation and, if applicable, after drying and/or swelling or steeping, the β-glucan is re-dissolved in water. In this context, the water may be high-purity/ultrapure water (also referred to as “aqua purificata” or “aqua purified” according to European Pharmacopoeia (PhEur) or US Pharmacopeia (USP)). Also, the water may contain further ions or particles, or further EOR-compounds like inter alia: acids such as methanesulfonic acid (e.g., Baso MSA™); biocides such as glutaraldehyde or THPS (e.g., Protectol® or Myacide®); clean-up agents such as decanol ethoxylates (e.g., Basosol™ XP); corrosion inhibitors such as acetylene derivatives (e.g., Basocorr™); surfactants such as alkylpolyglycosides, alkoxylates or decanol ethoxylates (e.g., Basoclean™ or Basosol™ XP); friction reducers such as polyacrylamide based polymers (e.g., Alcomer® 788 or Alcomer® 889); nonemulsifiers such as alkoxylates (e.g., Basorol®); scale dissolvers/inhibitors such as amine based oligo acetic acids (e.g., Basosolve®); oxygen scavengers such as sodium sulfate or sodium bisulfate or wetting agents such as sulfosuccinate diester (e.g., Alcomer® D1235). The step of re-dissolving β-glucan can be performed by methods known in the art and as also described and exemplified herein. For example, the water may be added to the β-glucan by re-dissolving technologies (e.g., under pneumatic, hydraulic or mechanical stirring, or by static or dynamic mixers such as dispersing machines) at ambient or elevated temperature. In addition, particularly (but not only) in case the β-glucan has a low residual moisture (e.g., below about 15% and/or has not been swelled or steeped before re-dissolving, the β-glucan may be torn, cut, hackled, or otherwise be reduced to smaller stripes or particles before being re-dissolved in water. The amount of water used for re-dissolving in context with the method described and provided herein may be an amount sufficient to reach the volume of the β-glucan solution before precipitation. Generally, in context with the present invention, a β-glucan solution is considered re-dissolved if no precipitate or solid can be seen anymore after centrifugation of the solution at 10,000 g for 2 min.

Generally, in context with the present invention, the β-glucan to be precipitated and re-dissolved as described herein may be any β-glucan. In one embodiment, the β-glucan is a polymer consisting of a linear main chain of β-D-(1-3)-glucopyranosyl units having a single β-D-glucopyranosyl unit (1-6) linked to a β-D-glucopyranosyl unit of the linear main chain with an average branching degree of about 0.3. In context with the present invention, the term “average branching degree about 0.3” may mean that in average about 3 of 10 β-D-(1-3)-glucopyranosyl units are (1-6) linked to a single β-D-glucopyranosyl unit. In this context, the term “about” may mean that the average branching degree may be within the range from 0.25 to 0.35, preferably from 0.25 to 0.33, more preferably from 0.27 to 0.33, most preferably from 0.3 to 0.33. It may also be 0.3 or 0.33. Schizophyllan, scleroglucan, pendulan, cinerian, laminarin, lentinan and pleuran all have an average branching degree between 0.25 and 0.33 (Novak, loc cit; Survase, loc cit); for example, scleroglucan and schizophyllan have an average branching degree of 0.3 to 0.33. The average branching degree of a β-glucan can be determined by methods known in the art, e.g., by periodic oxidation analysis, methylated sugar analysis and NMR (Brigand, Industrial Gums, Academic Press, New York/USA (1993), 461-472).

In context with the present invention, the β-glucan to be precipitated and re-dissolved as described herein may be selected from the group consisting of schizophyllan, scleroglucan, pendulan, cinerian, laminarin, lentinan and pleuran. For example, the β-glucan may be schizophyllan or scleroglucan, particularly schizophyllan.

As mentioned, the PEG used in context with the method described and provided herein has a molecular weight of at least 1,500 Da. In one embodiment, the PEG has a molecular weight of at least 8,000 Da. In another embodiment, the PEG has a molecular weight of at least 20,000 Da.

In context with the method of the present invention, the aqueous β-glucan solution, after being contacted with PEG, may comprise at least 20 g, preferably at least 25 g, more preferably at least 30 g, more preferably at least 35 g, more preferably at least 36 g, more preferably at least 37 g, more preferably at least 38 g, more preferably at least 39 g, and most preferably at least 40 g PEG per liter solution. Furthermore, the aqueous β-glucan solution, after being contacted with PEG, may comprise not more than 80 g, preferably not more than 70 g, more preferably not more than 65 g, more preferably not more than 62.5 g, and most preferably not more than 40 g PEG per liter solution. For example, the aqueous β-glucan solution, after being contacted with PEG, may comprise 25 g to 80 g, 25 g to 70 g, 30 g to 70 g, 30 g to 62.5 g, 30 g to 50 g, or, preferably, 30 g to 40 g PEG per liter solution.

In one aspect, the present invention relates to a method for precipitating and re-dissolving schizophyllan comprising the following steps:
(a) contacting an aqueous schizophyllan solution with a polyethylene glycol (PEG) having a molecular weight of at least about 1,500 Da, thereby precipitating the schizophyllan;
(b) isolating the precipitated schizophyllan from the aqueous solution;
(c) optionally drying the precipitated schizophyllan of (b);
(d) optionally swelling or steeping the precipitated schizophyllan of (b) or (c) in an aqueous solution; and
(e) re-dissolving the precipitated schizophyllan of (b), (c) or (d) in water.

In another aspect, the present invention relates to a method for precipitating and re-dissolving scleroglucan comprising the following steps:
(a) contacting an aqueous scleroglucan solution with a polyethylene glycol (PEG) having a molecular weight of at least about 1,500 Da, thereby precipitating the scleroglucan;
(b) isolating the precipitated scleroglucan from the aqueous solution;
(c) optionally drying the precipitated scleroglucan of (b);
(d) optionally swelling or steeping the precipitated scleroglucan of (b) or (c) in an aqueous solution; and
(e) re-dissolving the precipitated scleroglucan of (b), (c) or (d) in water.

In another aspect, the present invention relates to a method for precipitating and re-dissolving β-glucan comprising the following steps:
(a) contacting an aqueous β-glucan solution with a polyethylene glycol (PEG) having a molecular weight of at least about 8,000 Da, thereby precipitating the β-glucan;
(b) isolating the precipitated β-glucan from the aqueous solution;
(c) optionally drying the precipitated β-glucan of (b);
(d) optionally swelling or steeping the precipitated β-glucan of (b) or (c) in an aqueous solution; and
(e) re-dissolving the precipitated β-glucan of (b), (c) or (d) in water.

In another aspect, the present invention relates to a method for precipitating and re-dissolving schizophyllan comprising the following steps:
(a) contacting an aqueous schizophyllan solution with a polyethylene glycol (PEG) having a molecular weight of at least about 8,000 Da, thereby precipitating the schizophyllan;
(b) isolating the precipitated schizophyllan from the aqueous solution;
(c) optionally drying the precipitated schizophyllan of (b);
(d) optionally swelling or steeping the precipitated schizophyllan of (b) or (c) in an aqueous solution; and
(e) re-dissolving the precipitated schizophyllan of (b), (c) or (d) in water.

In another aspect, the present invention relates to a method for precipitating and re-dissolving scleroglucan comprising the following steps:
(a) contacting an aqueous scleroglucan solution with a polyethylene glycol (PEG) having a molecular weight of at least about 8,000 Da, thereby precipitating the scleroglucan;
(b) isolating the precipitated scleroglucan from the aqueous solution;
(c) optionally drying the precipitated scleroglucan of (b);
(d) optionally swelling or steeping the precipitated scleroglucan of (b) or (c) in an aqueous solution; and
(e) re-dissolving the precipitated scleroglucan of (b), (c) or (d) in water.

In another aspect, the present invention relates to a method for precipitating and re-dissolving β-glucan comprising the following steps:
(a) contacting an aqueous β-glucan solution with a polyethylene glycol (PEG) having a molecular weight of at least about 20,000 Da, thereby precipitating the β-glucan;
(b) isolating the precipitated β-glucan from the aqueous solution;
(c) optionally drying the precipitated β-glucan of (b);
(d) optionally swelling or steeping the precipitated β-glucan of (b) or (c) in an aqueous solution; and
(e) re-dissolving the precipitated β-glucan of (b), (c) or (d) in water.

In another aspect, the present invention relates to a method for precipitating and re-dissolving schizophyllan comprising the following steps:
(a) contacting an aqueous schizophyllan solution with a polyethylene glycol (PEG) having a molecular weight of at least about 20,000 Da, thereby precipitating the schizophyllan;
(b) isolating the precipitated schizophyllan from the aqueous solution;
(c) optionally drying the precipitated schizophyllan of (b);
(d) optionally swelling or steeping the precipitated schizophyllan of (b) or (c) in an aqueous solution; and
(e) re-dissolving the precipitated schizophyllan of (b), (c) or (d) in water.

In another aspect, the present invention relates to a method for precipitating and re-dissolving scleroglucan comprising the following steps:
(a) contacting an aqueous scleroglucan solution with a polyethylene glycol (PEG) having a molecular weight of at least about 20,000 Da, thereby precipitating the scleroglucan;
(b) isolating the precipitated scleroglucan from the aqueous solution;
(c) optionally drying the precipitated scleroglucan of (b);
(d) optionally swelling or steeping the precipitated scleroglucan of (b) or (c) in an aqueous solution; and
(e) re-dissolving the precipitated scleroglucan of (b), (c) or (d) in water.

In another aspect, the present invention relates to a method for precipitating and re-dissolving β-glucan comprising the following steps:
(a) contacting an aqueous β-glucan solution with a polyethylene glycol (PEG) having a molecular weight of at least about 1,500 Da, thereby precipitating the β-glucan;
(b) isolating the precipitated β-glucan from the aqueous solution;
(c) optionally drying the precipitated β-glucan of (b);
(d) optionally swelling or steeping the precipitated β-glucan of (b) or (c) in an aqueous solution; and
(e) re-dissolving the precipitated β-glucan of (b), (c) or (d) in water,
   wherein said aqueous β-glucan solution, after being contacted with polyethylene glycol, comprises 30 g to 62.5 g polyethylene glycol per liter.

In another aspect, the present invention relates to a method for precipitating and re-dissolving schizophyllan comprising the following steps:
(a) contacting an aqueous schizophyllan solution with a polyethylene glycol (PEG) having a molecular weight of at least about 1,500 Da, thereby precipitating the schizophyllan;
(b) isolating the precipitated schizophyllan from the aqueous solution;
(c) optionally drying the precipitated schizophyllan of (b);
(d) optionally swelling or steeping the precipitated schizophyllan of (b) or (c) in an aqueous solution; and
(e) re-dissolving the precipitated schizophyllan of (b), (c) or (d) in water,
   wherein said aqueous schizophyllan solution, after being contacted with polyethylene glycol, comprises 30 g to 62.5 g polyethylene glycol per liter.

In another aspect, the present invention relates to a method for precipitating and re-dissolving scleroglucan comprising the following steps:
(a) contacting an aqueous scleroglucan solution with a polyethylene glycol (PEG) having a molecular weight of at least about 1,500 Da, thereby precipitating the scleroglucan;
(b) isolating the precipitated scleroglucan from the aqueous solution;
(c) optionally drying the precipitated scleroglucan of (b);
(d) optionally swelling or steeping the precipitated scleroglucan of (b) or (c) in an aqueous solution; and
(e) re-dissolving the precipitated scleroglucan of (b), (c) or (d) in water,
   wherein said aqueous scleroglucan solution, after being contacted with polyethylene glycol, comprises 30 g to 62.5 g polyethylene glycol per liter.

In another aspect, the present invention relates to a method for precipitating and re-dissolving β-glucan comprising the following steps:
(a) contacting an aqueous β-glucan solution with a polyethylene glycol (PEG) having a molecular weight of at least about 8,000 Da, thereby precipitating the β-glucan;
(b) isolating the precipitated β-glucan from the aqueous solution;
(c) optionally drying the precipitated β-glucan of (b);
(d) optionally swelling or steeping the precipitated β-glucan of (b) or (c) in an aqueous solution; and
(e) re-dissolving the precipitated β-glucan of (b), (c) or (d) in water,
   wherein said aqueous β-glucan solution, after being contacted with polyethylene glycol, comprises 30 g to 62.5 g polyethylene glycol per liter.

In another aspect, the present invention relates to a method for precipitating and re-dissolving schizophyllan comprising the following steps:
(a) contacting an aqueous schizophyllan solution with a polyethylene glycol (PEG) having a molecular weight of at least about 8,000 Da, thereby precipitating the schizophyllan;
(b) isolating the precipitated schizophyllan from the aqueous solution;
(c) optionally drying the precipitated schizophyllan of (b);
(d) optionally swelling or steeping the precipitated schizophyllan of (b) or (c) in an aqueous solution; and
(e) re-dissolving the precipitated schizophyllan of (b), (c) or (d) in water,
   wherein said aqueous schizophyllan solution, after being contacted with polyethylene glycol, comprises 30 g to 62.5 g polyethylene glycol per liter.

In another aspect, the present invention relates to a method for precipitating and re-dissolving scleroglucan comprising the following steps:
(a) contacting an aqueous scleroglucan solution with a polyethylene glycol (PEG) having a molecular weight of at least about 8,000 Da, thereby precipitating the scleroglucan;
(b) isolating the precipitated scleroglucan from the aqueous solution;
(c) optionally drying the precipitated scleroglucan of (b);
(d) optionally swelling or steeping the precipitated scleroglucan of (b) or (c) in an aqueous solution; and
(e) re-dissolving the precipitated scleroglucan of (b), (c) or (d) in water,
   wherein said aqueous scleroglucan solution, after being contacted with polyethylene glycol, comprises 30 g to 62.5 g polyethylene glycol per liter.

In another aspect, the present invention relates to a method for precipitating and re-dissolving β-glucan comprising the following steps:
(a) contacting an aqueous β-glucan solution with a polyethylene glycol (PEG) having a molecular weight of at least about 20,000 Da, thereby precipitating the β-glucan;
(b) isolating the precipitated β-glucan from the aqueous solution;
(c) optionally drying the precipitated β-glucan of (b);
(d) optionally swelling or steeping the precipitated β-glucan of (b) or (c) in an aqueous solution; and
(e) re-dissolving the precipitated β-glucan of (b), (c) or (d) in water,
   wherein said aqueous β-glucan solution, after being contacted with polyethylene glycol, comprises 30 g to 62.5 g polyethylene glycol per liter.

In another aspect, the present invention relates to a method for precipitating and re-dissolving schizophyllan comprising the following steps:
(a) contacting an aqueous schizophyllan solution with a polyethylene glycol (PEG) having a molecular weight of at least about 20,000 Da, thereby precipitating the schizophyllan;
(b) isolating the precipitated schizophyllan from the aqueous solution;
(c) optionally drying the precipitated schizophyllan of (b);
(d) optionally swelling or steeping the precipitated schizophyllan of (b) or (c) in an aqueous solution; and
(e) re-dissolving the precipitated schizophyllan of (b), (c) or (d) in water,
   wherein said aqueous schizophyllan solution, after being contacted with polyethylene glycol, comprises 30 g to 62.5 g polyethylene glycol per liter.

In another aspect, the present invention relates to a method for precipitating and re-dissolving scleroglucan comprising the following steps:
(a) contacting an aqueous scleroglucan solution with a polyethylene glycol (PEG) having a molecular weight of at least about 20,000 Da, thereby precipitating the scleroglucan;
(b) isolating the precipitated scleroglucan from the aqueous solution;
(c) optionally drying the precipitated scleroglucan of (b);
(d) optionally swelling or steeping the precipitated scleroglucan of (b) or (c) in an aqueous solution; and
(e) re-dissolving the precipitated scleroglucan of (b), (c) or (d) in water,
   wherein said aqueous scleroglucan solution, after being contacted with polyethylene glycol, comprises 30 g to 62.5 g polyethylene glycol per liter.

In another aspect, the present invention relates to a method for precipitating and re-dissolving β-glucan comprising the following steps:
(a) contacting an aqueous β-glucan solution with a polyethylene glycol (PEG) having a molecular weight of at least about 1,500 Da, thereby precipitating the β-glucan;
(b) isolating the precipitated β-glucan from the aqueous solution;
(c) optionally drying the precipitated β-glucan of (b);
(d) optionally swelling or steeping the precipitated β-glucan of (b) or (c) in an aqueous solution; and
(e) re-dissolving the precipitated β-glucan of (b), (c) or (d) in water,
   wherein said aqueous β-glucan solution, after being contacted with polyethylene glycol, comprises 30 g to 40 g polyethylene glycol per liter.

In another aspect, the present invention relates to a method for precipitating and re-dissolving schizophyllan comprising the following steps:
(a) contacting an aqueous schizophyllan solution with a polyethylene glycol (PEG) having a molecular weight of at least about 1,500 Da, thereby precipitating the schizophyllan;
(b) isolating the precipitated schizophyllan from the aqueous solution;
(c) optionally drying the precipitated schizophyllan of (b);
(d) optionally swelling or steeping the precipitated schizophyllan of (b) or (c) in an aqueous solution; and
(e) re-dissolving the precipitated schizophyllan of (b), (c) or (d) in water,
   wherein said aqueous schizophyllan solution, after being contacted with polyethylene glycol, comprises 30 g to 40 g polyethylene glycol per liter.

In another aspect, the present invention relates to a method for precipitating and re-dissolving scleroglucan comprising the following steps:
(a) contacting an aqueous scleroglucan solution with a polyethylene glycol (PEG) having a molecular weight of at least about 1,500 Da, thereby precipitating the scleroglucan;
(b) isolating the precipitated scleroglucan from the aqueous solution;
(c) optionally drying the precipitated scleroglucan of (b);
(d) optionally swelling or steeping the precipitated scleroglucan of (b) or (c) in an aqueous solution; and
(e) re-dissolving the precipitated scleroglucan of (b), (c) or (d) in water,
   wherein said aqueous scleroglucan solution, after being contacted with polyethylene glycol, comprises 30 g to 40 g polyethylene glycol per liter.

In another aspect, the present invention relates to a method for precipitating and re-dissolving β-glucan comprising the following steps:
(a) contacting an aqueous β-glucan solution with a polyethylene glycol (PEG) having a molecular weight of at least about 8,000 Da, thereby precipitating the β-glucan;
(b) isolating the precipitated β-glucan from the aqueous solution;
(c) optionally drying the precipitated β-glucan of (b);
(d) optionally swelling or steeping the precipitated β-glucan of (b) or (c) in an aqueous solution; and
(e) re-dissolving the precipitated β-glucan of (b), (c) or (d) in water,
   wherein said aqueous β-glucan solution, after being contacted with polyethylene glycol, comprises 30 g to 40 g polyethylene glycol per liter.

In another aspect, the present invention relates to a method for precipitating and re-dissolving schizophyllan comprising the following steps:
(a) contacting an aqueous schizophyllan solution with a polyethylene glycol (PEG) having a molecular weight of at least about 8,000 Da, thereby precipitating the schizophyllan;
(b) isolating the precipitated schizophyllan from the aqueous solution;
(c) optionally drying the precipitated schizophyllan of (b);
(d) optionally swelling or steeping the precipitated schizophyllan of (b) or (c) in an aqueous solution; and
(e) re-dissolving the precipitated schizophyllan of (b), (c) or (d) in water,
   wherein said aqueous schizophyllan solution, after being contacted with polyethylene glycol, comprises 30 g to 40 g polyethylene glycol per liter.

In another aspect, the present invention relates to a method for precipitating and re-dissolving scleroglucan comprising the following steps:
(a) contacting an aqueous scleroglucan solution with a polyethylene glycol (PEG) having a molecular weight of at least about 8,000 Da, thereby precipitating the scleroglucan;
(b) isolating the precipitated scleroglucan from the aqueous solution;
(c) optionally drying the precipitated scleroglucan of (b);
(d) optionally swelling or steeping the precipitated scleroglucan n of (b) or (c) in an aqueous solution; and
(e) re-dissolving the precipitated scleroglucan of (b), (c) or (d) in water,
   wherein said aqueous scleroglucan solution, after being contacted with polyethylene glycol, comprises 30 g to 40 g polyethylene glycol per liter.

In another aspect, the present invention relates to a method for precipitating and re-dissolving β-glucan comprising the following steps:
(a) contacting an aqueous β-glucan solution with a polyethylene glycol (PEG) having a molecular weight of at least about 20,000 Da, thereby precipitating the β-glucan;
(b) isolating the precipitated β-glucan from the aqueous solution;
(c) optionally drying the precipitated β-glucan of (b);
(d) optionally swelling or steeping the precipitated β-glucan of (b) or (c) in an aqueous solution; and
(e) re-dissolving the precipitated β-glucan of (b), (c) or (d) in water,
   wherein said aqueous β-glucan solution, after being contacted with polyethylene glycol, comprises 30 g to 40 g polyethylene glycol per liter.

In another aspect, the present invention relates to a method for precipitating and re-dissolving schizophyllan comprising the following steps:
(a) contacting an aqueous schizophyllan solution with a polyethylene glycol (PEG) having a molecular weight of at least about 20,000 Da, thereby precipitating the schizophyllan;
(b) isolating the precipitated schizophyllan from the aqueous solution;
(c) optionally drying the precipitated schizophyllan of (b);
(d) optionally swelling or steeping the precipitated schizophyllan of (b) or (c) in an aqueous solution; and
(e) re-dissolving the precipitated schizophyllan of (b), (c) or (d) in water,
   wherein said aqueous schizophyllan solution, after being contacted with polyethylene glycol, comprises 30 g to 40 g polyethylene glycol per liter.

In another aspect, the present invention relates to a method for precipitating and re-dissolving scleroglucan comprising the following steps:
(a) contacting an aqueous scleroglucan solution with a polyethylene glycol (PEG) having a molecular weight of at least about 20,000 Da, thereby precipitating the scleroglucan;
(b) isolating the precipitated scleroglucan from the aqueous solution;
(c) optionally drying the precipitated scleroglucan of (b);
(d) optionally swelling or steeping the precipitated scleroglucan of (b) or (c) in an aqueous solution; and
(e) re-dissolving the precipitated scleroglucan of (b), (c) or (d) in water,
   wherein said aqueous scleroglucan solution, after being contacted with polyethylene glycol, comprises 30 g to 40 g polyethylene glycol per liter.

The Figures show:

FIG. 1: Relative viscosity of glucan solution with increasing addition of PEG

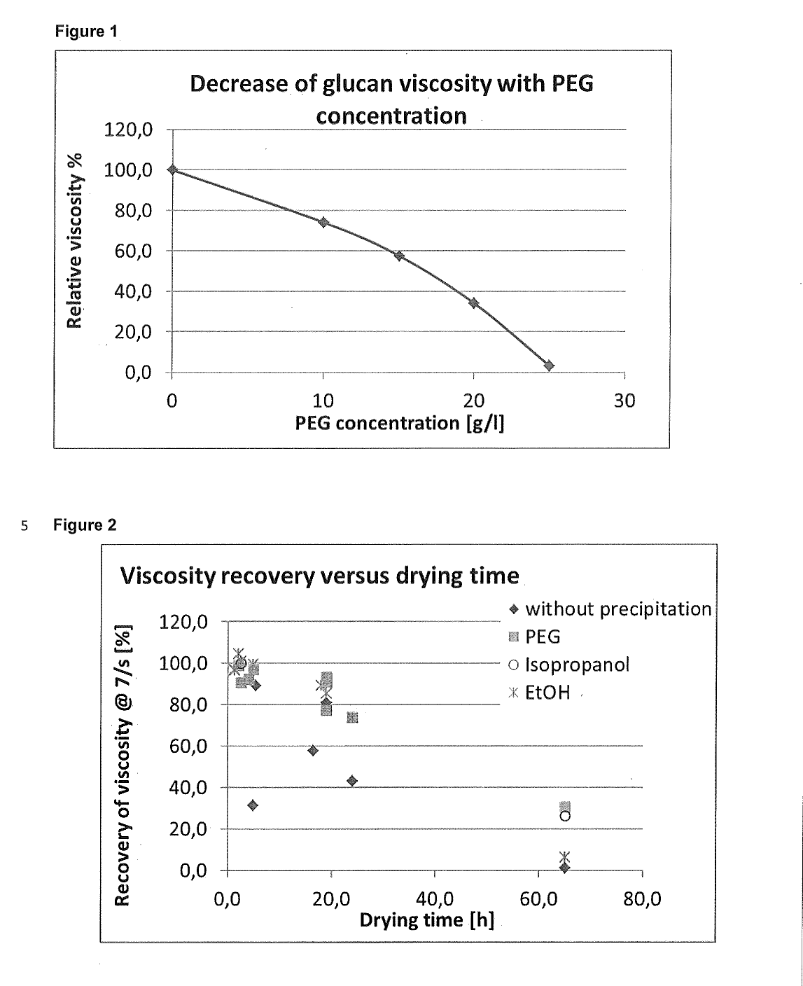

FIG. 2: Viscosity recovery as a function of drying time

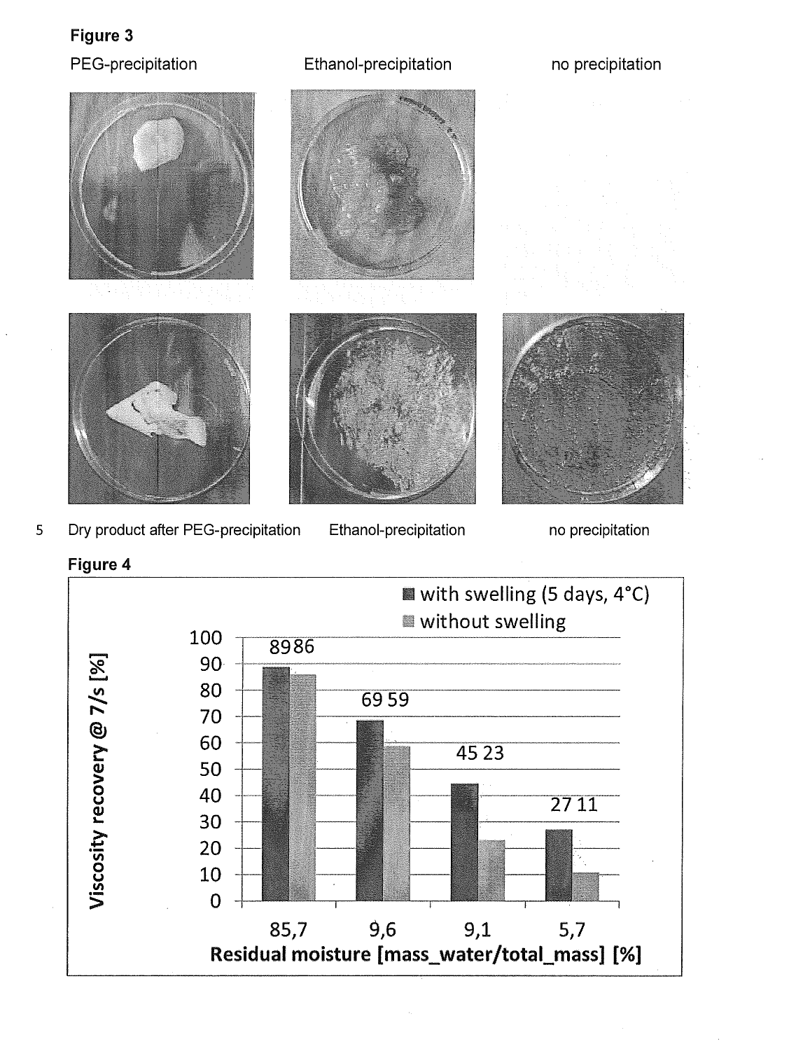

FIG. 3: Images of different precipitated and dried glucan materials

FIG. 4: Viscosity recovery with and without swelling as a function of residual moisture. Moisture was measured after drying, before swelling.

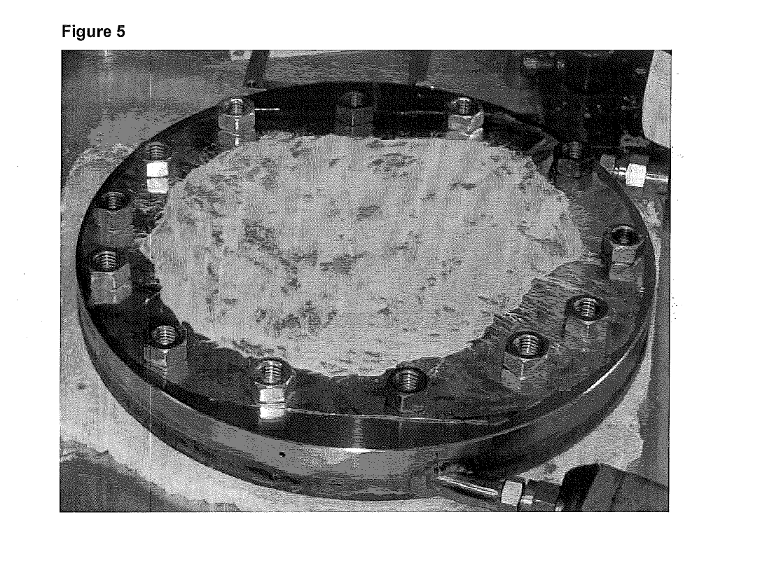

FIG. 5: Image of dried glucan on heating plate

As described herein above and below, in context with the present invention, methods have been found with which β-glucans such as, e.g., schizophyllan can be re-dissolved after drying and high viscosity yields can be obtained. The following Examples illustrate the present invention.

### EXAMPLES

Unless specified otherwise, viscosity yields are ascertained by comparing the viscosity at a shear rate of 7/s after re-dissolving of a dried sample with the viscosity of the starting solution before drying with the same volume: Furthermore, unless specified otherwise, all experiments were performed at room temperature at ambient pressure. Finally, unless specified otherwise herein, the following experiments were performed with schizophyllan as representative β-glucan. However, the experiments may also be performed mutatis mutandis with other β-glucans to be precipitated and re-dissolved in context with the present invention as described herein above. As such, the following Examples must not be construed as limiting the present invention to the embodiments described therein.

### Example 1

### Drying Experiments with PEG Precipitation and Redissolution After Drying

Experiment Description

In one experiment, schizophyllan was precipitated with polyethylene glycol (PEG), dried and then this was re-dissolved again (in the same volume as the starting solution). This experiment showed that β-glucan precipitated with PEG can be re-dissolved after drying with very high viscosity yields.

Procedure

Precipitation

From three analogously prepared samples* (sample 1, sample 2, sample 3), 40 g samples of permeate solution were introduced into a conical centrifugation tube.

*The samples were prepared by fermentation from Schizophyllum commune and subsequent separation of the biomass by crossflow filtration.

5 g of PEG8000 50% w/w were added to the samples. The samples were then mixed for 1 min in a vortex mixer and by hand shaking. During this, schizophyllan precipitates, which was then centrifuged off (2 min at 8500 rpm (10,000 g)). The supernatant was then decanted off.

Drying

The precipitate was then removed from the centrifuge tube and spread out flat on a plastic Petri dish. It was then dried in a drying cabinet at 67° C. for several hours (until the mass was constant).

Re-Dissolving

The dried solid was manually comminuted, i.e. torn into small strips.

For the re-dissolving, the material was placed in a 100 ml beaker and topped up in stages, with stirring, to the original 40 g in order to restore the starting concentration of glucan. The entire sample was then transferred to two conical centrifuge tubes and dispersed for 2 min using Ultraturrax (3800 rpm; T25 digital Ultra-Turrax from IKA). To check whether the entire solid had re-dissolved, the sample was centrifuged for 2 min at 8500 rpm (10,000 g). Non-dissolved solids collect at the bottom and become visible. If this second phase was observed during the centrifugation, the mixture was ultraturraxed again for 2 min at 3800 rpm. The process was repeated until no sedimented phase was visible after centrifugation.

Results

The tables below show the results of the experiment. The β-glucan concentration after the precipitation is 116-185 g/L and is therefore very high. Upon precipitation with PEG, hardly any β-glucan remains in the supernatant. The viscosity property, which is the main value of schizophyllan for many applications, could be achieved again completely for all samples by the procedure (reference: starting sample). This is true both for the level of the viscosity and also for the property of shear dilution. Furthermore, the precipitation and re-dissolving with PEG leads to a decolored, white/beige solution, whereas the starting solution appears yellowish. This shows that R-Glucan is not only concentrated in this step but also purified.

TABLE 1
Precipitate from 40 g sample

| | | | | β-glucan |
|---|---|---|---|---|
| Sample | Mass of | β-glucan | Mass after | content |
| No. | precipitate [g] | precipitate [g/L] | drying [g] | dry mass [%] |
| Sample 1 | 2.457 | 116.0 | 0.4149 | 68.68 |
| Sample 2 | 1.136 | 185.1 | 0.2512 | 83.73 |
| Sample 3 | 0.817 | 146.2 | 0.1758 | 67.95 |

TABLE 2
Mass Balance

| Sample | Glucan | Glucan | Total glucan | Total |
|---|---|---|---|---|
| No. | supernatant [g] | precipitate [g] | original [g] | glucan [g] |
| Sample 1 | 0.017 | 0.285 | 0.282 | 0.302 |
| Sample 2 | 0.025 | 0.210 | 0.196 | 0.236 |
| Sample 3 | 0.031 | 0.119 | 0.150 | 0.151 |

TABLE 3
Supernatant

| | Total | Glucan | Glucan | Viscosity (shear rate) | | |
|---|---|---|---|---|---|---|
| Sample No. | mass [g] | [g/L] | [g] | 7/s | 100/s | 1000/s |
| Sample 1 | 38.4 | 0.43 | 0.017 | 6.03 | 2.92 | 2.79 |
| Sample 2 | 42.8 | 0.59 | 0.025 | 6.19 | 2.76 | 2.7 |
| Sample 3 | 43.1 | 0.73 | 0.031 | 6.65 | 2.93 | 2.81 |

TABLE 4
Overview

| | Glucan g/L | | | | | | | |
|---|---|---|---|---|---|---|---|---|
| | | After | | | | Viscosity after re- | | |
| | | drying | Viscosity original | | | dissolving. | | |
| Sample | | and re- | | | 1000/ | | | 1000/ |
| No. | original | dissolving | 7/s | 100/s | s | 7/s | 100/s | s |
| Sample | 7.06 | 7.12 | 1650 | 146 | 20.1 | 1660 | 143 | 20.6 |
| 1 | | | | | | | | |
| Sample | 4.89 | 5.26 | 1160 | 108 | 16.3 | 1190 | 116 | 18.5 |
| 2 | | | | | | | | |
| Sample | 3.74 | 2.99 | 584 | 59.3 | 10.6 | 536 | 52.6 | 9.19 |
| 3 | | | | | | | | |

### Example 2

### Determination of the Amount of PEG Required for the Precipitation of Glucan as a Function of the PEG Molecular Weight

Experiment Description

It was investigated for various glucan samples how much PEG, with a different molecular weight, is necessary for complete precipitation with subsequent centrifugal removal of the precipitated phase.

It is found that the PEG molecular weight has an important influence on the required amount of PEG for the precipitation; furthermore, it is found that the required amount of PEG is independent of the glucan concentration.

PEG polymers with the molecular weights 1.5; 8 and 20 kDa were used.

Experiment Procedure

From three analogously prepared samples* (sample 1, sample 2, sample 3), in each case 10 g of sample were introduced into a 15 ml centrifuge tube.

Each of the three samples was additionally diluted 1:1 with ultrapure water such that the concentration was in each case also halved; using this diluted sample, the experiment was likewise carried out in each case in order to examine a concentration influence of the glucan.

*The samples were prepared by fermentation of Schizophyllum commune and subsequent separation of the biomass by crossflow filtration.

PEG stock solution (aqueous PEG solution; 50% w/w) was added, mixed, and centrifuged for 4 min at 8500 rpm. This was carried out until the schizophyllan had completely precipitated. Completely precipitated was defined as being when the upper phase was clear and contained no streaks, such that two homogeneous, distinct layers (precipitate and upper phase) had formed. In the case of just too low a PEG concentration, there were two glucan phases, or a three-phase mixture with a clear phase at the top, a high-viscosity middle phase and the rubber-like precipitate.

The required amount of PEG was converted to concentration and is given below.

Results

Tables 5 to 7 shown below present the experimental results data. The PEG concentration indicates the final max. PEG concentration required in each case.

A clear influence by the PEG chain length with regard to the required amount of PEG is evident. The larger the PEG molecular weight, the less the amount required for complete precipitation. By contrast, the concentration influence of the glucan itself was low. This means that the required amount of PEG is independent of the β-glucan concentration and thus the specific PEG demand for precipitation drops, as the glucan concentration increases.

TABLE 5
Sample 1

| | PEG length [kDa] | | |
|---|---|---|---|
| | 20.0 | 8.0 | 1.5 |
| β-glucan concentration | PEG | | |
| [g/L] | concentration (max) [g/L] | | |
| 6.8 | 31.9 | 38.1 | 65.8 |
| 3.4 | 33.7 | 36.9 | 66.3 |

TABLE 6
Sample 2

| | PEG length [kDa] | | |
|---|---|---|---|
| β-glucan concentration | 20.0 | 8.0 | 1.5 |
| [g/L] | PEG concentration (max) [g/L] | | |
| 9.6 | 34.6 | 38.0 | 79.6 |
| 4.8 | 30.7 | 37.6 | 77.2 |

TABLE 7
Sample 3

| | PEG length [kDa] | | |
|---|---|---|---|
| β-glucan concentration | 20.0 | 8.0 | 1.5 |
| [g/L] | PEG concentration (max) [g/L] | | |
| 5.6 | 29.7 | 37.1 | 63.9 |
| 2.8 | 29.7 | 37.2 | 65.5 |

Summary

The higher the chain length of the PEG, the lower the required amount of PEG which was necessary for a precipitation. The required amount of PEG is independent of the glucan concentration in the experiments carried out.

### Example 3

### Precipitation of a Solution with High Glucan Concentrations

Experiment Description

In Example 2, it was found that β-glucan can be precipitated with PEG of molecular weight 20 kDa at a concentration of max. about 35 g/L PEG ˜30 to 35 g/L), independently of the β-glucan concentration. It is shown below that β-glucan precipitation is also possible at high β-glucan concentrations (up to 68 g/L) with PEG at a concentration of max. 35 g/L.

Experiment Procedure

The experiment procedure for determining the required amount of precipitate is analogous to that of Example 2. However, in this case, β-glucan solutions were first concentrated prior to use.

Sample 1 was produced by evaporating 286 g of a β-glucan (schizophyllan) sample solution by rotary evaporation. The mass of the material after evaporation was 6.7 g and was rinsed from the flask with 35 ml of water. The β-glucan concentration obtained here was 68 g/L β-glucan. Using this sample, the precipitation was carried out and the required concentration of PEG was determined.

Sample 2 was produced by precipitating a sample of β-glucan (schizophyllan) permeate by adding PEG. The precipitate was separated by centrifugation, had a concentration of 111.2 g/L β-glucan and was then diluted 1:1 so that a β-glucan concentration of 56 g/L was established. This sample was then precipitated again with PEG.

Results

For sample 1, a PEG precipitation was completely possible at a PEG concentration of 30 g/L. For sample 2, the precipitation was complete at 35 g/L. Both precipitations show that the PEG concentration (PEG 20 kDa), even in the case of concentrations between 50 and 70 g/L glucan, the minimum PEG concentration for precipitation is independent of the glucan concentration, as can be seen from this Example and especially in light of Example 2 herein. In order to reduce the amount of PEG used in an economical process, it is therefore possible to first concentrate β-glucan by means of various methods, such as evaporation or ultrafiltration, and then to carry out a precipitation with PEG.

### Example 4

### Decrease in the Viscosity with Increasing PEG Concentration

Experiment Description

The experiment below/together with FIG. 1) describes how the viscosity of a β-glucan solution behaves prior to complete precipitation by illustrating it as a function of the amount of PEG added.

Experiment Procedure

PEG (20 kDa) was added in stages to a sample of β-glucan solution (permeate) until the PEG concentration was 25 g/L. The viscosity of the sample was measured at a shear rate of 7/s and determined relative to the starting viscosity.

Result

As can be taken from FIG. 1, the viscosity decreases considerably with increasing PEG concentration. This can potentially be utilized during processing since the viscosity is a limiting factor in many process steps with β-glucan solutions. Even at 15-20 g/L PEG, a viscosity decrease was observed visually, and upon further addition of PEG, the solution became milky and cloudy. However, no clear two phases formed upon centrifugation for 2 min at 8500 rpm (10000 g).

### Example 5

### Precipitation Experiments with Glycerol

Experiment Description

The aim was to examine whether precipitation with glycerol as a similar compound is likewise possible.

Experiment Procedure

10 g of β-glucan solution sample were charged to a test tube and then glycerol (pure) was added in order to produce a precipitation.

Experiment Result

Up to an addition of 35 g of glycerol, no precipitation was observed. At this 3.5-fold amount of the starting solution, the experiment was terminated. That is, precipitation with glycerol was not possible.

### Example 6

### Precipitation with PEG, Ethanol, Isopropanol for Comparison

Experiment Description

β-glucan (schizophyllan) solution samples were precipitated with PEG, ethanol and iso-propanol in order to investigate differences with regard to the β-glucan concentration as a result of precipitation, re-dissolvability and the cleaning effect as a result of the precipitation.

Experiment Procedure

Procedure for PEG Precipitation

For precipitation, a 50% strength (w/w) stock solution of PEG 20 kDa and ultrapure water was prepared. For this, equal mass fractions of PEG 20 kDa and ultrapure water were combined in a laboratory flask and mixed for 1 h at room temperature on a magnetic stirrer (stage 4-5; magnetic stirrer RCT from IKA) until a clear, bubble-free solution was formed.

The β-glucan solution was combined in a centrifuge tube (50 mL) at room temperature with PEG 20 kDa stock solution such that the concentration in the precipitation solution is 30 g/L PEG, and shaken and/or vortexed for 1 min. The sample was centrifuged for 2 min at 8,500 rpm (10,000 g). The supernatant was discarded and the precipitate was removed from the centrifuge tube by means of a spatula.

Procedure for Ethanol/Isopropanol Precipitation

The precipitation of the β-glucan was performed at room temperature by adding 0.75 parts of ethanol or isopropanol per 1 part of permeate (based on the mass). The sample was then shaken and/or vortexed for 1 min until a clear phase separation was evident. Finally, phase separation was carried out by centrifugation for 2 min at 8,500 rpm (10,000 g). After discarding the supernatant, the precipitate was used for further experimental steps.

Procedure for Drying

The precipitates were each spread out flatly on a plastic Petri dish and dried in a convection drying oven at 67° C. for 4 h (unless specified otherwise).

Procedure for Re-Dissolving

To re-dissolve a dry material precipitated with PEG, it was cut into strips ca. 5 mm in width and placed in a 100 ml beaker with stirrer fish. The ethanol/isopropanol precipitated or non-precipitated and dried materials were first sprinkled with about 2 ml of ultrapure water and, after a swelling time of 2 min at room temperature, transferred from the Petri dish to a 100 ml beaker with stirrer fish. The use of water for the transfer of dried material after ethanol/isopropanol precipitation was needed to completely transfer the dried sample.

Approximately 20 ml of ultrapure water were added to the 100 ml beaker and stirred. After a stirring time of 10 min, the softened solid samples were comminuted using a 1 ml syringe. For this, the samples were drawn up into the syringe and forced out against the beaker so that the lumps were comminuted by the shear which arises. The pretreated samples were finally transferred to a 50 ml centrifuge tube and topped up to the starting mass (initial weight) with AP water. The back-diluted samples were turraxed in the centrifuge tube for 2 min at 3,800 rpm and then centrifuged off for 2 min at 8,500 rpm (10,000 g). The turraxing and centrifuging off were repeated twice. The sample was interpreted as being re-dissolved when no precipitate was formed after the last centrifugation step. This was examined visually.

Results

Influence of the Drying Time on the Viscosity Yield

The influence of the drying time on the viscosity yields is illustrated in FIG. 2. It was found that when the drying time is too long, the viscosity yield decreases with the drying time both in the case of the precipitated materials and also in the case of non-precipitated materials. Additional investigations revealed that the residual moisture, which decreases with increasing drying time, is apparently the reason for this fact. As has been found, the residual moisture should preferably not go below 5% w/w (liquid/β-glucan) as can be also taken from Example 7.

Furthermore, it was seen that materials which have been precipitated beforehand (PEG, ethanol or isopropanol) exhibit a clearer profile with regard to the viscosity yield whereas the non-precipitated samples fluctuate to a greater extent with regard to their viscosity yield following re-dissolving of the dried sample.

Influence of the Drying Temperature on the Viscosity Yield

A sample after PEG precipitation was dried both at 67° C. and at 138° C. The viscosity yield is compared in Table 8.

TABLE 8
Impact of temperature on recovered viscosity yield

| | Centrifugation upper/ | Recovery rate of viscosity |
|---|---|---|
| Temperature | lower phase | at 7/s |
| 1 - PEG 30 g/L | 2 phases | 92% |
| 67° C. | viscous/creamy | |
| 2 - PEG 30 g/L | not dissolved/solid leaf- | 0.4% |
| 138° C. | lets in aqueous solution | |

At a high drying temperature (here 138° C.), the viscosity yield became very low.

Summary:

Both a long drying time and also a high drying temperature (both leading to a lower residual moisture) result in a lower viscosity yields. This has to be taken into consideration in an industrial process by drying for a short time and/or at low temperature.

Influence of the Precipitant on Purification of the Glucan and on Glucan Concentration by Precipitation

Visually, it can be seen that the substance precipitated with PEG is firstly considerably smaller (higher glucan concentration), and secondly is also white and therefore purer than is the case without precipitation or with ethanol precipitation; see FIG. 3. The PEG precipitation can thus be used for purifying the β-glucan solution and thus represents an alternative to diafiltrations or extractions.

Concentration of Glucan by PEG and Ethanol Precipitation

Table 9 provides results in which, in each case, 20 g of different samples have been precipitated, dried and dissolved again to give 20 g of solution.

TABLE 9
Concentration of glucan by PEG and ethanol precipitation

| | | | | | concentration | |
|---|---|---|---|---|---|---|
| | | | | after | of glucan in the | |
| | | | after drying | redissolution | precipitate | |
| Original | Glucan | | Dry mass | Glucan | Glucan | concentration |
| Sample | [g/l] | | [g] | [g/l] | [g/l] | factor |
| | | after PEG | | | | |
| | | precipitation | | | | |
| | | Precipitate | | | | |
| | | wet [g] | | | | |
| 1 | 4.44 | 0.61 | 0.17 | 4.2 | 139 | 33 |
| 2 | 7.32 | 1.04 | 0.24 | 6.6 | 127 | 19 |
| 3 | 6.52 | 0.56 | 0.17 | 6.2 | 222 | 36 |
| | | after EtoH | | | | |
| | | precipitation | | | | |
| | | Precipitate | | | | |
| | | wet [g] | | | | |
| 1 | 4.44 | 4.70 | 0.13 | 3.9 | 16.6 | 4.3 |
| 2 | 7.32 | 8.57 | 0.21 | 4.9 | 11.5 | 2.3 |
| 3 | 6.52 | 7.83 | 0.19 | 6.1 | 15.5 | 2.6 |

In the case of the precipitation with PEG, a considerably higher β-glucan concentration of the precipitate is established. Concentrating a β-glucan solution by a factor of 36 to above 200 g/L was possible. Furthermore, the amount for the precipitation is considerably lower for PEG. Only 0.6 g of PEG were used for the precipitation, whereas 15 g of ethanol were used.

Influence of the Amount of PEG on the Precipitate Mass, or the Precipitate Volume

It was investigated to what extent the precipitate mass of glucan depends on the amount of PEG used For this, PEG (20 kDa) was added in different concentrations to in each case 20 g of a 6.5 g/L glucan solution. 30, 40 and 62.5 g/L of PEG were added and precipitated by the method described above and separated off.

The result of precipitation with different PEG concentrations are shown in Table 10.

TABLE 10
Precipitation with different PEG concentrations

| PEG 20 kDa | | Supernatant | b-glucan precipitate | |
|---|---|---|---|---|
| 50% [g/L] | PEG [g] | [g] | wet [g] | Dry mass [g] |
| 30.0 | 0.60 | 19.7 | 1.39 | 0.1620 |
| 40.0 | 0.80 | 20.8 | 0.66 | 0.1556 |
| 62.5 | 1.25 | 21.9 | 0.55 | 0.1476 |

As the PEG concentration increases, the β-glucan wet mass decreases, or the β-glucan concentration in the precipitate increases. This means that by increasing the amount of PEG for a given separation method of the precipitate, it is possible to influence the precipitate concentration, or the amount of water therein.

### Example 7

### Influence of a Swelling Phase and Influence of the Residual Moisture on the Viscosity Yield

Experiment Description

β-glucan was PEG-precipitated as described in Example 6. However, the sample amounts used were larger; precipitation was carried out in a beaker such that 60 g of precipitate were generated.

After precipitation, the material (60 g precipitate) was dried in a convection oven at 67° C. for 3.5 h; part was removed, and the remainder was dried for a further 17.5 h, after which again part of the dry substance was removed. The remainder was dried further for 24 h at 70° C. in a vacuum drying cabinet at 5 mbar.

The residual moistures of the amounts removed in each case were determined by means of mass balance and/or Karl-Fischer titration:

Precipitate (not dried): residual moisture (g of water/total mass): 85.7%

After convection drying for 3.5 h: 9.6%

After convection drying for 21 h: 9.1%

After convection drying for 21 h+vacuum drying for 24 h: 5.7%

The dry masses generated in this way were adjusted again to the starting concentration before the precipitation (analogously to “Precipitation with PEG, ethanol, isopropanol in comparison”) and the viscosity yield was determined; furthermore, in each case, additionally some of the dry sample was stored for 5 days in ultrapure water in a refrigerator before the original concentration was established. This is referred to below as swelling:

Results

The determination of residual moisture is illustrated in FIG. 4. As residual moisture decreases, the viscosity yield decreases considerably; furthermore, the swelling leads to an increase in the viscosity yield. Consequently, in an industrial process, the residual moisture is to be regarded as a decisive criterion and a minimal residual moisture of at least 5%, or preferably at least 10% should not be underrun.

### Example 8

### Improvement in the Viscosity Yield as a Result of Swelling

Experiment Description

The following experiment was aimed at investigating to what extent a swelling phase at 40° C. can be advantageous for dried samples.

Experiment Procedure

Precipitation and drying were carried out as described in “Precipitation with PEG, ethanol, isopropanol in comparison”. However, the materials were dried in each case for 65 h.

The dried materials were dissolved on the one hand as in “Precipitation with PEG, ethanol, isopropanol in comparison”, but furthermore also swelled for 18 h at 40° C. before the final dispersion and starting concentration were established.

Results

Table 11 shows the viscosity yield which was achieved after precipitation and drying for 65 h at 67° C. (without swelling phase).

TABLE 11
Viscosity yields after drying

| | | | | Viscosity |
|---|---|---|---|---|
| Sample | 7/s | 100/s | 1000/s | yields at 7/s [%] |
| Original | 727 | 71.2 | 11.7 | 100 |
| PEG | 222 | 25.4 | 5.96 | 30 |
| EtOH | 46 | 7.68 | 2.75 | 6 |
| i-PrOH | 190 | 21.1 | 5.76 | 26 |

The same dried samples were furthermore treated with a swelling phase, i.e. stirred for 18 h in ultrapure water at 40° C., before the intensive re-dissolving with the Ultraturrax.

TABLE 12
Intense re-dissolving

| | | | | Recovery |
|---|---|---|---|---|
| Sample | 7/s | 100/s | 1000/s | rate at 7/s [%] |
| Original | 727 | 71.2 | 11.7 | 100 |
| PEG | 458 | 47.9 | 9.09 | 63 |
| EtOH | 305 | 32.3 | 6.77 | 41 |
| i-PrOH | 432 | 44.2 | 8.77 | 59 |

Summary

The considerably increased viscosity yields in each case demonstrate that the swelling phase is likewise a means for achieving high viscosities.

### Example 9

### Drying on a Scalable Scale

Experiment Description

Experiments were carried out on a small scale which could be converted to scalable apparatuses:

a) spray drying (experiment on miniature scale)

b) drum drying (experiment on hot-plate)

This demonstrates the industrial translatability of the laboratory experiments.

The two experiments were carried out with a PEG-precipitated β-glucan precipitate.

Experiment Procedure

a) Hot-Plate Experiment

β-glucan precipitate* was spread out thinly on a hot-plate (see FIG. 5) (precipitate layer thickness ca. 1 mm) and dried for 15 min at 67° C. The area of the hot-plate is ca. 240 cm².

*4×25 g Permeat (R61-2009-04 Mp1R1) were precipitated with 3,125 g PEG 20 kDa PEG 50% each. Then they were centrifuged at 1000 g for 2 min. Precipitates were mixed.

Result for Hot-Plate

The dried product had a residual moisture of 8%, which was determined with Karl-Fischer titration. The product was film-like.

After re-dissolving, 84% of the starting viscosity was achieved. Viscosity data after re-dissolving is shown in Table 13.

TABLE 13
Viscosity after re-dissolving

| Shear | Viscosity after re-dissolving [mPa s] |
|---|---|
| 7/s | 1520 |
| 100/s | 140 |
| 1000/s | 21.4 |
| % at 7/s | 84 |

b) Experiment with Spray Drying

A precipitate was produced by means of PEG precipitation by precipitating 1000 ml of a β-glucan solution sample (6.8 g/L β-glucan) with 125 g of PEG solution (50% PEG). The material was centrifuged by centrifugation at 1000 g for 1 min.

The precipitate produced in this way was dried in a spray dryer at 25 Nm³/h (gas inlet temperature 135-141° C.).

The dried material was again re-dissolved to the starting volume of the original sample (cf. Example 6, supra) and the viscosity yield was determined.

Results

The spray drying produced threads 1 mm to 5 cm in length. These could be re-dissolved very easily. The viscosity yield was very high as can be taken from Table 14.

TABLE 14
Viscosity yields after spray drying

| | 7/s | 100/s | 1000/s | β-glucan content [g/L] |
|---|---|---|---|---|
| Re-dissolved | 1460 | 129 | 18.7 | 7.21 |
| Original | 1460 | 132 | 19.4 | 6.78 |
| Viscosity [%] | 100 | 97.7 | 96.4 | 106.3 |

Summary

After drying by means of the two methods, it was possible to achieve a high viscosity compared to the starting solution when using the same amounts of dried substance as in the starting solution; this means that contact drying or spray drying are possible methods for the industrial drying of β-glucan if the aim is to achieve high viscosity yields upon re-dissolving.

1.-8. (canceled)

9. Method for precipitating and re-dissolving β-glucan comprising:
(a) contacting an aqueous β-glucan solution with a polyethylene glycol having a molecular weight of at least 1,500 Da, thereby precipitating the β-glucan;
(b) isolating the precipitated β-glucan from the aqueous solution;
(c) optionally drying the precipitated β-glucan of (b);
(d) optionally steeping the precipitated β-glucan of (b) or (c) in an aqueous solution; and
(e) re-dissolving the precipitated β-glucan of (b), (c) or (d) in water.

10. Method according to claim 9, wherein said β-glucan is a polymer consisting of a linear main chain of β-D-(1-3)-glucopyranosyl units having a single β-D-glucopyranosyl unit (1-6) linked to a β-D-glucopyranosyl unit of the linear main chain with an average branching degree of about 0.3.

11. Method according to claim 9, wherein said β-glucan is selected from the group consisting of schizophyllan, scleroglucan, pendulan, cinerian, laminarin, lentinan and pleuran.

12. Method according to claim 9, wherein said polyethylene glycol has a molecular weight of at least 8,000 Da or at least 20,000 Da.

13. Method according to claim 9, wherein said aqueous β-glucan solution which is contacted with said polyethylene glycol has a concentration of at least 2.5 g β-glucan per liter.

14. Method according to claim 9, wherein said aqueous β-glucan solution, after being contacted with polyethylene glycol, comprises at least 20 g polyethylene glycol per liter.

15. Method according to claim 9, wherein said aqueous β-glucan solution, after being contacted with polyethylene glycol, comprises not more than 80 g polyethylene glycol per liter.

16. Method according to claim 9, wherein said isolation of the precipitated β-glucan is performed by centrifugation, sedimentation or filtration.
